(19) United States
(12) Patent Application Publication
(10) Pub. No.: US 2018/0228310 A1
(43) Pub. Date: Aug. 16, 2018

(54) DELIVERY ENCLOSURE

(71) Applicants: Amadin Enobakhare, Saint Albans, NY (US); Mariame Barry, east Orange, NJ (US); Shivendu Bhalla, New Hyde Park, NY (US)

(72) Inventors: Amadin Enobakhare, Saint Albans, NY (US); Mariame Barry, east Orange, NJ (US); Shivendu Bhalla, New Hyde Park, NY (US)

(21) Appl. No.: 15/894,879

(22) Filed: Feb. 12, 2018

Related U.S. Application Data
(60) Provisional application No. 62/459,035, filed on Feb. 14, 2017.

(51) Int. Cl. A47G 29/12; E06B 5/00; E05B 49/00

(52) U.S. Cl. CPC A47G 29/1207; E05B 49/00; E06B 5/00

(57) ABSTRACT

Embodiments of the present invention provide a delivery enclosure configurable onto a door or like platform. The enclosure includes sections forming the pair of side covers, the top cover, the bottom cover, wherein each of the sections is sized such as to enable collapsing of one section over the successive section, a scissorian assembly comprising at least two arms configured onto each of the pair of side covers connecting the sections together, a handle operationally connected to one of the arms on each of the pair of side covers, wherein a pull of the handle by a resident enables the enclosure to attain at least one of an expanded configuration and a collapsed configuration, and an electronic locking system provided on the front cover for securely locking one or more deliveries within the secure compartment.

### CROSS REFERENCE TO RELATED APPLICATION

This application claims the benefit of U.S. Provisional Application No. 62/459,035 filed on Feb. 14, 2017, which is incorporated by reference herein.

### FIELD OF THE INVENTION

The present disclosure relates to the field of dropboxes, and particularly to a secured delivery enclosure configurable onto a door or like support platforms of a residence. More particularly, present disclosure is directed towards a collapsible and electronically lockable delivery enclosure configurable onto a door.

### BACKGROUND

Typically, when we see around us, we find different types of lockable storage devices installed in common areas of housing complexes or private properties for receiving various objects such as parcels, mails or other deliveries from various shippers or mail service providers. Also, we can see some property owners install some delivery boxes enabled with padlocks near the entrance door of their home. Such devices require home owners to be in or around their home for receiving the objects, when the shipper or the deliveries arrive at their address. People residing in such complexes or properties especially when they are not home have difficulty in having objects delivered or collected in a safe and secure way without granting the delivery or collection person an access into their property.

Further, with the rise in various convenience services such as online shopping over various web portals and home collection and return of laundry and dry-cleaning etc, a solution is needed for such deliveries and collections to occur safely without anyone being present at the residence or property.

U.S. Pat. No. 4,909,052 in the name of Hutwohl et al discloses a door safe or box for mounting on the front door of a home and especially adapted for use in the delivery and pick-up of articles such as videotapes while the residents are not at home.

U.S. Pat. No. 6,945,451 in the name of Bridges et al discloses a mail receptacle. The mail receptacle of Bridges includes an exterior portion and an interior portion which are attached to opposing sides of a door. The exterior portion is accessible from outside and used for delivering the mails, whereas the interior portion is accessible by the property owner from inside. For the security purpose, the mail receptacle is provided with padlock.

While the above-described U.S. Pat. No. 4,909,052 and U.S. Pat. No. 6,945,451 may be satisfactory in some respects, but they do have shortcomings. For example, U.S. Pat. No. 6,945,451 may enable delivery of mails by the mail service providers from the front of door when the property owner is not at home, but when the property owner requires a parcel or delivery be collected by the shipper or the mail service provider then in that case, in the absence of property owner, the shipper or the collection person may not be able to collect the delivery. Similarly, U.S. Pat. No. 4,909,052 allows the accessibility to the door safe from front of the door, but is not accessible from inside the property and lacks mechanism that ensure security of the deliveries when the property owner is away and when the property owner desire a parcel or delivery be collected by the shipper or the mail service provides.

In the light of aforementioned background, there is a need for an improved delivery enclosure configurable on the front door of the property that would alleviate drawbacks associated with conventional dropboxes.

### BRIEF SUMMARY

The present invention solves the problem of delivery and pick-up of the deliveries by providing a delivery enclosure configurable outside the residence door, wherein the delivery enclosure is accessible by both a delivery person and the residents. More specifically, the present invention provides a delivery enclosure accessible by the delivery person when the residents are not at home.

Embodiments of the present invention provide a delivery enclosure configurable onto a door or like platform. The enclosure (100) comprises of a plurality of sections (108a-108d) forming the pair of side covers (S1,S2), the top cover (A), the bottom cover (B), wherein each of the plurality of sections (108a-108d) is sized such as to enable collapsing of one section over the successive section; a scissorian assembly comprising at least two arms (114) configured onto each of the pair of side covers (S1,S2) connecting the plurality of sections (108a-108d) together; a handle (112) operationally connected to one of the arms (114) on each of the pair of side covers (S1,S2), wherein a pull of the handle (112) by a resident enables the enclosure (100) to attain at least one of an expanded configuration and a collapsed configuration; and an electronic locking system (104) provided on the front cover (102) for securely locking one or more deliveries within the secure compartment (120).

These and other features and advantages of the invention will become apparent from the detailed description below, in light of the accompanying drawings.

### BRIEF DESCRIPTION OF THE ACCOMPANYING DRAWINGS

The novel features which are believed to be characteristic of the present disclosure, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this disclosure will now be described by way of example in association with the accompanying drawings in which:

FIG. 1 shows a front perspective view of a secured delivery enclosure configured onto a door of a residence, in accordance with an embodiment of the present disclosure.

FIG. 2 shows a front perspective view of the secured delivery enclosure of FIG. 1 in an opened configuration for providing accessibility from front side of the door, in accordance with an embodiment of the present invention.

FIG. 3 shows a hinge mechanism embodied in the secured delivery enclosure of FIG. 2.

FIG. 4 shows a back perspective view of the secured delivery enclosure of FIG. 1 in a closed configuration restricting the access to the enclosure from back side of the door, in accordance with an embodiment of the present invention.

FIG. 5A-5B shows back perspective views of the secured delivery enclosure in partial and fully opened configurations for providing accessibility from back of the door.

FIG. 6 shows the secured delivery enclosure of FIG. 5B in a fully collapsed configuration.

FIG. 7 shows a sectional side view of the secured delivery enclosure in a fully expanded configuration, in accordance with an embodiment of the present invention.

FIG. 8 shows a rear view of the secured delivery enclosure configured onto the door of the residence using a bracket assembly, according to an embodiment of the present invention.

FIG. 9 shows a side view of the secured delivery enclosure configured onto the door of the residence in a fully expanded configuration, according to an embodiment of the present invention.

FIG. 10 shows a side view of the secured delivery enclosure configured onto the door of the residence in a fully collapsed configuration, according to an embodiment of the present invention.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

For the purpose of description, the utilization of the delivery enclosure in the present disclosure is described with reference to a door. However, the use of the enclosure of the present disclosure is not limited to only door and may be used for other kind of support platforms, such as a wall. The delivery enclosure of the present disclosure facilitates deliveries and collections of objects, such as parcels, mails or other deliveries to occur safely without anyone being present at the residence or the property.

The enclosure of the present disclosure provides higher safety using an electronic locking mechanism. Further, the enclosure of the present disclosure facilitates more space for the objects due to its collapsible and expansion feature. The enclosure of the present disclosure is very comfortable to operate and easily accessible from inside the property.

As used herein the terms “residence”, “property”, “house”, “home” and any variations thereof are all used synonymously in the context of present disclosure and should not be considered limiting. Further, the terms “mail service provider”, “shipper”, or “delivery person” and any variations thereof are all used synonymously in the context of present disclosure and should not be considered limiting. Further, the terms “home owner”, “property owner”, and any variations thereof, are all used synonymously in the context of present disclosure and should not be considered limiting. For the purpose of illustrations, the delivery enclosure of the present invention is shown configured onto the lower area of the door; however for a person skilled in the art, it should be apparent that the enclosure may also be configured onto the upper area of the door.

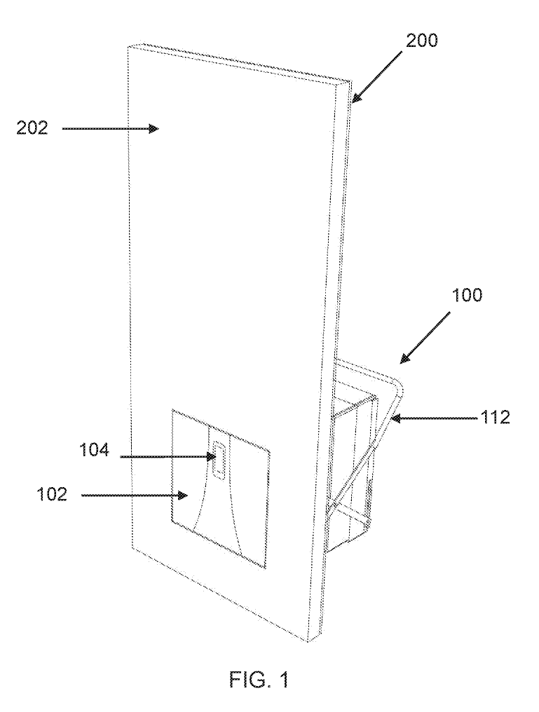

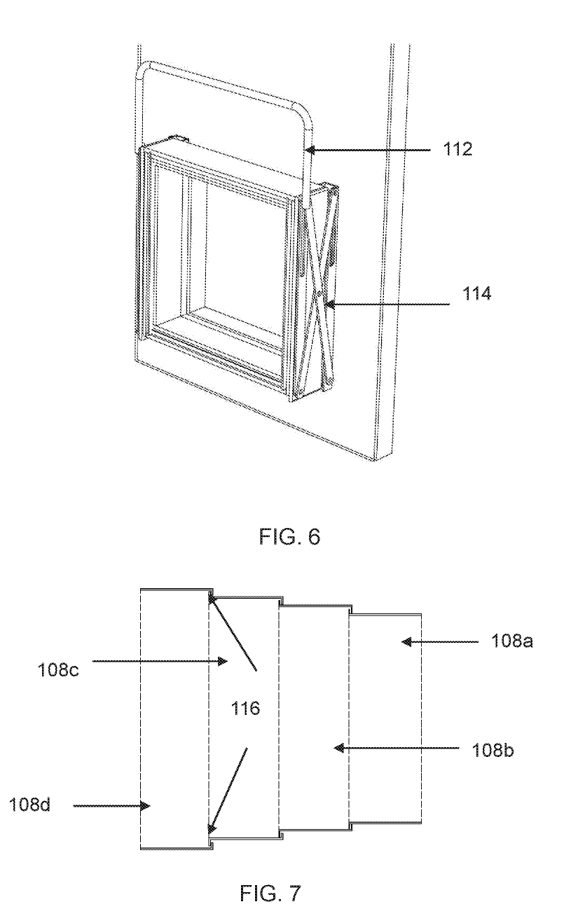

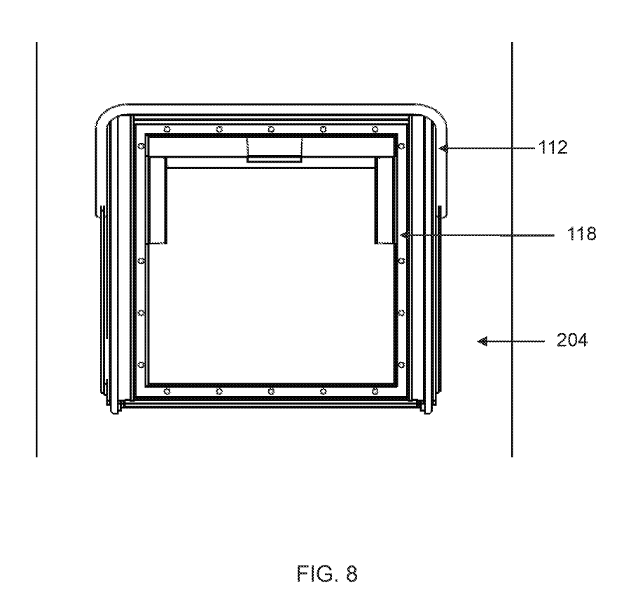

Referring to FIG. 1 through FIG. 10, there is shown a delivery enclosure (100) configurable onto a door (200) of a property. The delivery enclosure (100) of the present invention is preferably shown in cubical shape, however it should be understood that the scope of the present invention is not limited to the shape of the enclosure (100), the enclosure (100) of different shapes, such as rectangular may also be made without departing from the scope of present disclosure. The delivery enclosure (100) of the present invention may be fixedly attached onto the door (200) of the property using a bracket assembly (118), as shown in FIG. 8. The delivery enclosure (100) once configured may be accessible from a front side (202) and a back side (204) of the door (200).

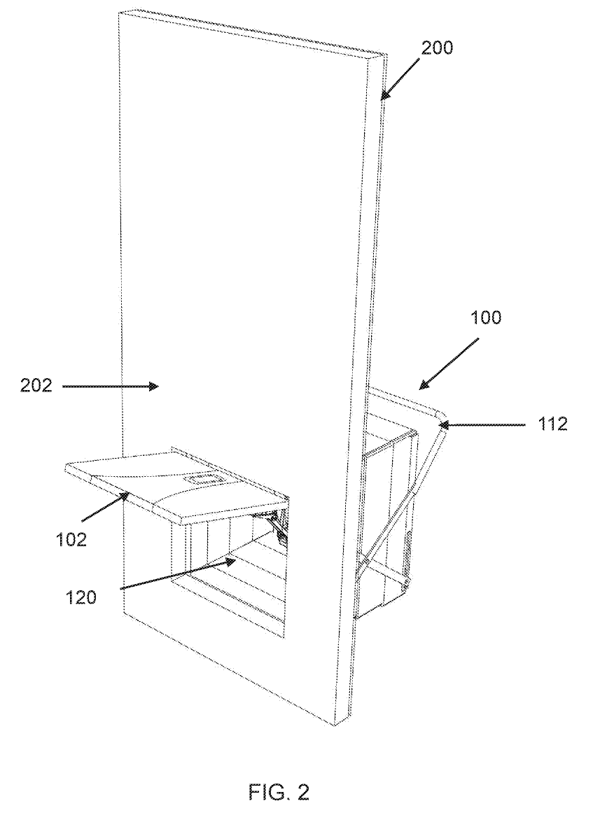

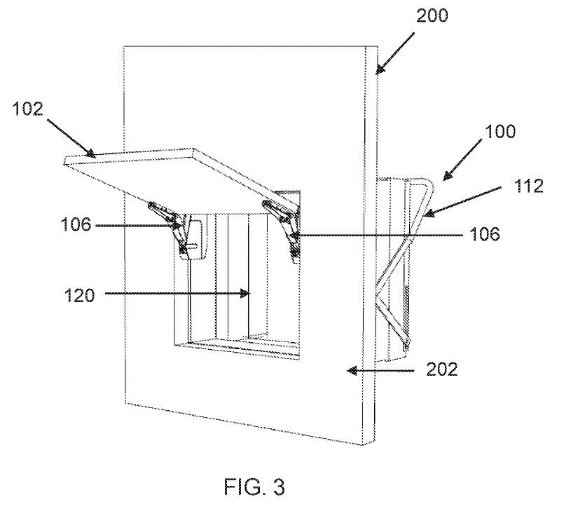

According to an embodiment of the present invention, the delivery enclosure (100) configurable onto the door (200) of the property includes a front cover (102) hingedly connected onto the mouth of an opening leading inside the enclosure (100), as shown in FIGS. 2-3. Although, a hinge mechanism (106) is shown illustrated, it should be understood any other suitable mechanism can also be used that would enable opening of the front cover (102). Further, in the example illustrations, it is shown that the front cover (102) swingably opens upward when someone opens the front cover (102) using a handle (not shown) provided on the front cover (102), as shown in FIGS. 2-3, it should be understood that the mechanism may also be configured such as to enable the front cover (102) to opens in a downward direction.

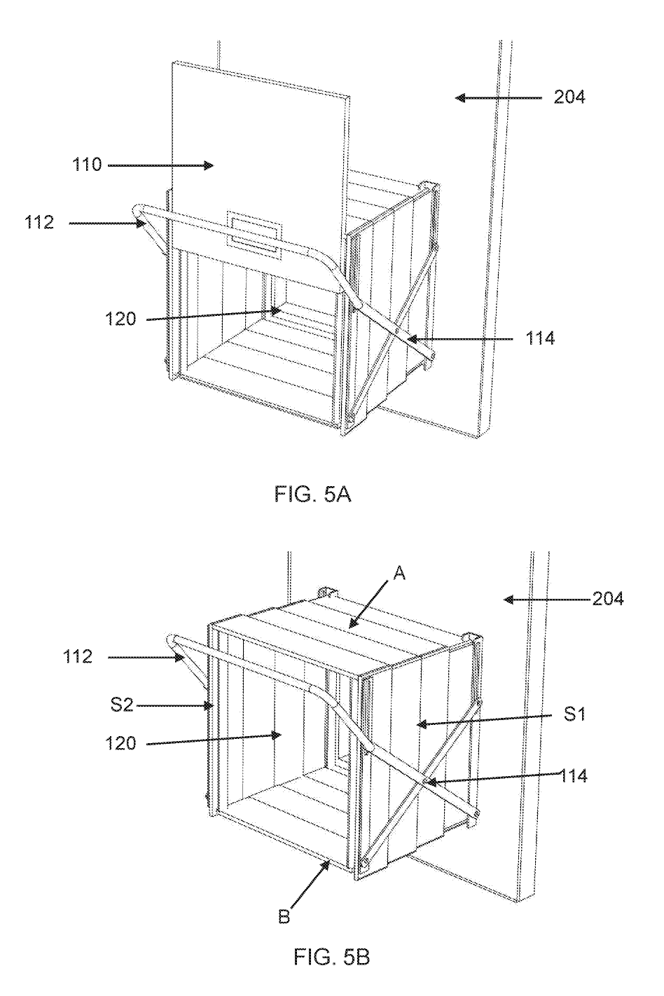

The delivery enclosure (100) further includes a back cover (110) in a slidable form as shown in FIG. 5A-5B. The back cover (110) can be slide opened easily to access the deliveries or the objects delivered therein by the property owner from inside their property or home.

The delivery enclosure (100) further includes a plurality of sections (108a-108d) forming a pair of side covers (S1,S2), a top cover (A), and a bottom cover (B) of the enclosure (100) as shown in FIG. 5B, which defines a compartment (120) meant for holding the deliveries or the objects. Each of the sections (108a-108d) are suitably designed in dimension such that the section 108a may collapse into the section 108b, similarly, the section 108b may collapse into the section 108c, and likewise the section 108c may collapse into the section 108d. For this to suitably happen, the section 108a is sized smaller (in terms of length and breadth) compared to the section 108b, the section 108b is sized smaller compared to the section 108c, and the section 108c is sized smaller compared to the section 108d. Further it should be understood by those skilled in the art that any number of sections may be utilized based on the requirement and design needs and scope of the present invention is not limited to the four sections shown in the example illustrations.

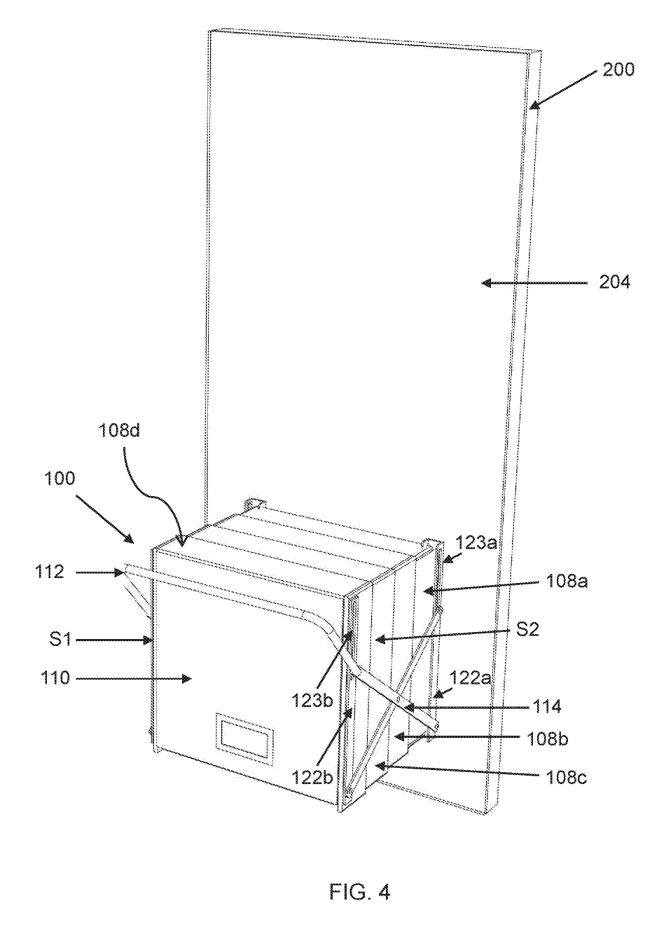

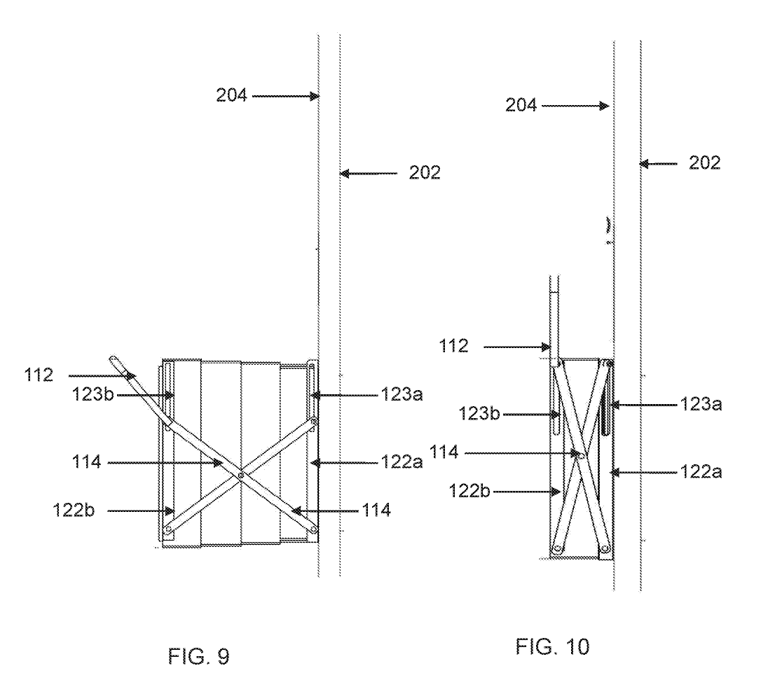

According to the embodiment, the enclosure (100) further includes a scissorian assembly comprising of at least two arms (114) configured onto each of the pair of side covers (S1,S2) connecting the plurality of sections (108a-108d) together, as best shown in FIG. 4. Although, the example illustrations shows two arms (114) configured on each of the side covers of the enclosure (100), it should be understood that more than two arms may also be used. The pair of arms (114) on each of the side covers (S1,S2) are enabled to slide over a pair of rail assemblies (123a,123b) configured over the bracket assemblies (122a,122b) provided on each of the side covers (S1,S2), as clearly seen in the FIG. 9 and FIG. 10. Each of the pair of arms (114) provided configured on each of the pair of side covers (S1,S2) are fixedly attached at one end onto the second set of bracket assemblies (122a,122b) and slidably engaged onto the rail assemblies (123a,123b) to enable the enclosure (100) to attain an expanded configuration and a collapsed configuration as best shown in FIGS. 9-10. This slide over mechanism is generally actuated when operating handle (112) attached to one of the arms (114) on both the side covers (S1,S2) is pulled by the property owner or when the shipper tries to open the enclosure (100) from outside by gentle push of hand to expand the enclosure (100), which is explained below considering an example scenario

According to the embodiment, the enclosure (100) may also be expanded by opening the front cover (102). For example, consider a scenario, when a delivery arrives and the delivery person is authorized to use the enclosure (100), then the delivery person may be able to open the front cover (102), and expand the enclosure (100) just by a gentle push of his hand towards the interior of the property to deliver the object. According to another alternative embodiment, an automatic actuation system or method may also be used for auto expansion of the enclosure (100) using one or more telescopic arms which might be operationally connected to the front cover (102).

Further according to the embodiment, the sections (108a-108d) are internally linked to one another using stopper means (116), as shown in FIG. 7. The stopper means (116) helps in retaining the sections (108a-108d) during the expanded configuration of the enclosure (100) by restricting the sections (108a-108d) getting out when the enclosure (100) expands.

According to the embodiment, the delivery enclosure (100) may be equipped with an electronic locking system (104) as shown in FIG. 1 for securely locking one or more deliveries or objects within the secure compartment (120). According to the example embodiment, the door (200) may have an electronic keypad (104), wherein the user (Eg. delivery person or shipper) may need to key in authentication credentials in order to be able to open the front cover (102) of the enclosure accessible from front side (202) of the door (200). According to the same embodiment, the authorization credentials may preferably be but not limited to a permanent key code, a temporary key code. The permanent key code may be a personal or master key code preferably usable by the property owners to open the front cover (102) of the enclosure (100). The temporary key code may be randomly generated and by the property owner with the delivery service providers or the shippers for enabling them to deliver or collect the objects from the property in the absence of the property owner. The temporary key code according to the embodiment is one time passwords (OTPs) comprising of alphabets, numeral or combination thereof which can be generated and shared by the property owner when needed. According to the embodiment, the permanent key code may be in the form of alphabets, numeral or alphanumeric. According to some other embodiments, the permanent code may be in the form of biometric recognition, such as finger print recognition or facial recognition or it may be enabled using some external credential management tools. According to the embodiment, the temporary key code may only last for a specific time period and may expire as soon as the time is reached. For example, the temporary key code may only be valid for 4 hours within which the shipper can have access to the enclosure's compartment (120).

Considering an example scenario where the property owner does some online shopping and is unavailable at the property for receiving the delivery from the shipper or the delivery service providers. In this case, the property owner can share randomly generated temporary key code while making the purchase. When the delivery arrives at the property, the delivery person or the shipper can simply key in the temporary key code on the electronic locking system (104) (Eg. electronic keypad) located on the front cover (102), this would enable the delivery person access the compartment (120) of the enclosure (100). The delivery person can just give a gentle push to expand the compartment (120) to interior side of the resident premise, in case the compartment (120) is not left in an expanded position by the property owner. According to another embodiment, the enclosure (100) may also be featured to self expansion, when the delivery person keys in the randomly generated temporary key code on the electronic key pad (104). According to an example, the self expansion may be featured using some telescopic arms that may be suitably configured to push the compartment inwards. The delivery person can then leave the delivery or the object inside the compartment (120). Later on when the property owner returns to his property or home, the owner is able to access the delivery either by opening the front cover (102) at the front of his door (202) using his permanent key code or access the delivery from inside his property by simply slide opening the back cover (110). Once the owner has received the delivery, then he can realign the enclosure (100) in the collapsed configuration by just a simple pull of the handle (112), if property owner so desires or else leave the enclosure (100) in the opened configuration. Alternatively, the enclosure (100) may be equipped with automated mechanism that may enable automatic collapsing of the compartment (120), once the property owner has retrieved the delivery.

According to some other embodiment, the enclosure (100) of the present invention may be configured to house an automatic control system (not shown), that may essentially comprise of but nor limited to, a memory, one or more transceivers, and one or more processors configured to execute a set of instructions or routines for accomplishing specific tasks. According to the embodiment, the property owner may be able to set or pre-configure a schedule for arrival of a delivery or may be able to send such command to the enclosure (100) in real time or as desired from a remote location using either normal messaging facilities like SMS, email or keys of his device and the like, Or alternatively, the property owner may have a dedicated software application that may connect communication device (Eg. smart phone) of the property owner to the enclosure (100) over a communication network (Eg. Internet) to enable the property owner to send and receive commands to and from the enclosure (100). The enclosure (100) may then act automatically when the scheduled date and/or time arrives or as soon as it receives commands from the property owner, and can self expand internally so that when the delivery person arrives, he can simply can key in randomly generated and shared temporary code onto the electronic key pad (104) without having to push the internal compartment for expansion.

Considering another example scenario, the property owner may desire a delivery to be collected or picked up by the shipper or the mail service provider while he is unavailable at the property when the shipper or the mail delivery person arrives for collecting the delivery. In this case, the property owner may keep the delivery inside the compartment (120) of the enclosure (100), may be by using the back cover (110) or the front cover (102) as described above and share the temporary key code with the mail service provider. When the collection person or the shipper arrives at the property for collecting the delivery, the collection person can simply key in the temporary key code on the electronic keypad (104) located on the front cover (102), this would enable the collection person access the compartment (120) of the enclosure (100). Later on, when the property owner, returns he can just verify the delivery is picked up or not by the collection person by simply opening either the front cover (102) or the back cover (110). According to some embodiment, such verification may be implemented using some sensor mechanism that might trigger some automatic notifications to be sent to the property owner when the deliveries are delivered or collected from the enclosure (100). In the context of present disclosure, as soon as the delivery is kept inside the enclosure (100) or the delivery is collected from the enclosure (100) by the shipper, the sensors (not shown) configured thereon will be able to sense such actions and send an automated notification to the property owners, preferably over their mobile communication devices (For Eg. phone).

The enclosure of the present invention may be made using any suitable material but not limited to steel, aluminum, plastic or any combination thereof. The use of material should not be construed as any limitation for implementation of the present invention; however the material is desired to have good durability and at the same time is inexpensive for the production and affordability of the end users.

Although particular embodiments of the invention have been described in detail for purposes of illustration, various modifications and enhancements may be made without departing from the spirit and scope of the invention.

We claim:

1. A delivery enclosure (100) configurable onto a door (200), the enclosure (100) having a front cover (102), a back cover (110), a pair of side covers (S1,S2), a top cover (A), and a bottom cover (B) forming a secure compartment (120), the enclosure (100), comprising:
a plurality of sections (108a-108d) forming the pair of side covers (S1,S2), the top cover (A), and the bottom cover (B), wherein each of the plurality of sections (108a-108d) is sized such as to enable collapsing of one section over the successive section;
a scissorian assembly comprising at least two arms (114) configured onto each of the pair of side covers (S1,S2) connecting the plurality of sections (108a-108d) together;
a handle (112) operationally connected to one of the arms (114) on each of the pair of side covers (S1,S2), wherein a pull of the handle (112) by a resident enables the enclosure (100) to attain at least one of an expanded configuration and a collapsed configuration; and
an electronic locking system (104) provided on the front cover (102) for securely locking one or more deliveries within the secure compartment (120).

2. The enclosure (100) of claim 1, wherein the size of each of the plurality of sections (108a-108d) includes a length and a breadth of each of the plurality of sections (108a-108d).

3. The enclosure (100) of claim 1 further comprising a first bracket assembly (118) for fixedly attaching the enclosure (100) on the door (200).

4. The enclosure (100) of claim 1 further comprising a pair of rail assemblies (123a,123b), each of the pair of rail assemblies (123a,123b) is fixedly attached to an end of a second set of bracket assemblies (122a,122b) on each of the side covers (S1,S2).

5. The enclosure (100) of claim 1, wherein each of the pair of arms (114) provided configured on each of the pair of side covers (S1,S2) are fixedly attached at one end onto the second set of bracket assemblies (122a,122b) and slidably engaged onto the rail assemblies (123a,123b) to enable the enclosure (100) to attain at least one of the expanded configuration and the collapsed configuration.

6. The enclosure (100) of claim 1, wherein the electronic locking system (104) comprises of an electronic keypad.

7. The enclosure (100) of claim 1, wherein the electronic locking system (104) allows access to the secure compartment (120) using at least one of a master key code, a temporary key code.

8. The enclosure (100) of claim 7, wherein the temporary key code provides an access to a shipper or a delivery service provider to deliver or pick the deliveries to and from the secure compartment (120).

9. The enclosure (100) of claim 7, wherein the master key code provides an access to a resident of a home to pick the deliveries from front side (202) of the door (200).

10. The enclosure (100) of claim 1, wherein the front cover (102) is hingedly connected onto a mouth of the compartment (120) leading inside the enclosure (100).

11. The enclosure (100) of claim 1, wherein the back cover (110) allows access to the compartment (120) of enclosure (100) from back side (204) of the door (200).
